(19) United States
(12) Patent Application Publication
(10) Pub. No.: US 2005/0141481 A1
(43) Pub. Date: Jun. 30, 2005

(54) Allocation of an s-cscf to a subscriber

(76) Inventor: Risto Kauppinen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/506,777

(22) PCT Filed: Mar. 7, 2003
(86) PCT No.: PCT/IB03/01280

(30) Foreign Application Priority Data
Mar. 7, 2002 (GB) 0205399.9

(51) Int. Cl. H04Q 7/24

(52) U.S. Cl. 370/352; 370/338

(57) ABSTRACT

There is disclosed a technique in which there is allocated one of a plurality of serving call state control functions to a subscriber, the technique including: receiving load information from at least one serving call state control function; and determining a serving call state control function for the subscriber in dependence on the received load information, wherein the receiving step includes receiving the load information during subscriber registration in a signal received from a serving call state control function to an interrogating call state control function.

### FIELD OF THE INVENTION

The present invention relates to the registration of a subscriber in a wireless network. The invention is applicable to the registration of a subscriber in a home network, whether the subscriber is roaming or not. The invention particularly relates to a technique for allocating a serving call state control function (S-CSCF) for such a subscriber based on the availability and load of the call state control functions located in the network.

### BACKGROUND TO THE INVENTION

As part of the registration of a mobile terminal in a home network, it is necessary for some resources to allocate a serving call state control function (S-CSCF). The S-CSCF is responsible for call routing, and provides a service control interface for a user towards application servers. A S-CSCF may be associated with a plurality of mobile terminals, and consequently may support the routing for a plurality of calls. A S-CSCF may support various types of calls or sessions, such as voice over IP calls and multimedia sessions, e.g. for gaming.

The resource that allocates the serving call state control function (S-CSCF) for a mobile terminal is an interrogating call state control function (I-CSCF), which includes the functionality of a S-CSCF allocation. For a mobile terminal in a home network, such an I-CSCF in the home network selects the S-CSCF for the mobile.

It has been proposed that one parameter that will be used by I-CSCF resource for selecting the serving call state control function for a mobile terminal registering in a network is the availability of serving call state control functions.

It is an object of the present invention to provide an improved technique for allowing the availability and the network load of a serving call state control function to be taken into account when allocating resources to a mobile terminal registering network.

### SUMMARY OF THE INVENTION

According to the present invention there is provided a method of allocating one of a plurality of serving call state control functions to a subscriber, the method including: receiving load information from at least one serving call state control function in a signalling message; and determining a serving call state control function for the subscriber in dependence on the received load information.

The method may further include receiving load information from a plurality of serving call state control functions.

The step of determining a serving call state control function may be carried out by a network resource. The network resource may be the interrogating call state control function. The network resource may be a home subscriber server.

The subscriber may be either located in a visited network or a home network and is registered in a home network.

The load information may indicate the actual current load of the serving call state control function. The load information may indicate the availability of the call state control function. The load information may indicate a time period in which the serving call state control function cannot receive further subscriber registrations.

The method may further include a session between a serving call state control function and interrogating call state control function for transmitting the availability information. The method may further include sessions between interrogating call state control function and a plurality of serving call state control functions. The method may further include transmitting an unavailability signal within the session from the serving call state control function to interrogating call state control function to indicate unavailability of the serving call state control to receive subscriber registrations.

The method may further include transmitting an availability signal within the session from the serving call state control function to the interrogating call state control function to indicate availability of the serving call state control function to receive subscriber registrations.

The method may further include transmitting a keep-alive signal within the session from the serving call state control function to the interrogating call state control function to indicate availability of the serving call state control function to receive subscriber registrations.

The signalling message may be related to subscriber registration. The signalling message may be related to a session between a serving call state control function and interrogating call state control function. The signalling message may be one of a 200 OK, INVITE, SUSPEND, or RESUME SIP Requests. The signalling message may be one of a Cx_Put, Cx_Put Resp, Cx_Pull, or a Cx_Pull Resp messages.

The serving call state control function may be selected on a session basis.

The subscriber may be located in a home network or a visited network, and the serving call state control function is located in the home network.

According to another aspect of the present invention there is provided a network element for allocating one of a plurality of serving call state control function means to a subscriber, the network including a home network comprising an interrogating call state control function means and a plurality of serving call state control function means; wherein the interrogating call state control function means receives load information from at least one of the serving call state control function means in a signalling message; and a broker associated with the network element determines a serving call state control function means for the subscriber in dependence on the received laod information.

The network element may be the interrogating call state control function. The network element may be a home subscriber server. The network may further include a visited network, wherein the subscriber is connected in either the visited network or the home network.

The interrogating call state control function means may receive load information from a plurality of serving call state control functions.

The load information may indicate the availability of a call state control function. The signalling message may be related to subscriber registration.

The network element may further include a session between a serving call state control function for transmitting for transmitting the availability information.

The signalling message may be related to a session between a serving call state control function and interrogating call state control function.

The signalling message may be one of a 200 OK, INVITE, SUSPEND, or RESUME SIP Requests. The signalling message may be one of a Cx_Put, Cx_Put Resp, Cx_Pull, or a Cx_Pull Resp messages.

In a still further aspect the present invention provides a mobile wireless communications system including a home network, wherein the home network includes a network element for allocating one of a plurality of serving call state control function means provided in the home network to a subscriber, the home network further comprising an interrogating call state control function means; wherein the interrogating call state control function means receives load information from at least one of the serving call state control function means; and a broker associated with the network element determines a serving call state control function means for the subscriber in dependence on the received load information.

The mobile wireless communication system may further include a visited network, wherein the subscriber is connected in either the visited network or the home network.

### BRIEF DESCRIPTION OF THE FIGURES

The invention will now be described by way of example with reference to the accompanying Figures, in which:

FIG. 1 shows a basic topology of a home network and a visited network;

FIG. 2 shows the stages of registration of a subscriber in the visited network of FIG. 1; and

FIG. 3 shows the continuation of the subscriber registration in which S-CSCF status information is provided for dynamic S-CSCF allocation in accordance with the invention.

### DESCRIPTION OF PREFERRED EMBODIMENTS

It will be understood that in the following description the present invention is described with reference to particular non-limiting examples from which the invention can be best understood. The invention, however, is not limited to such examples.

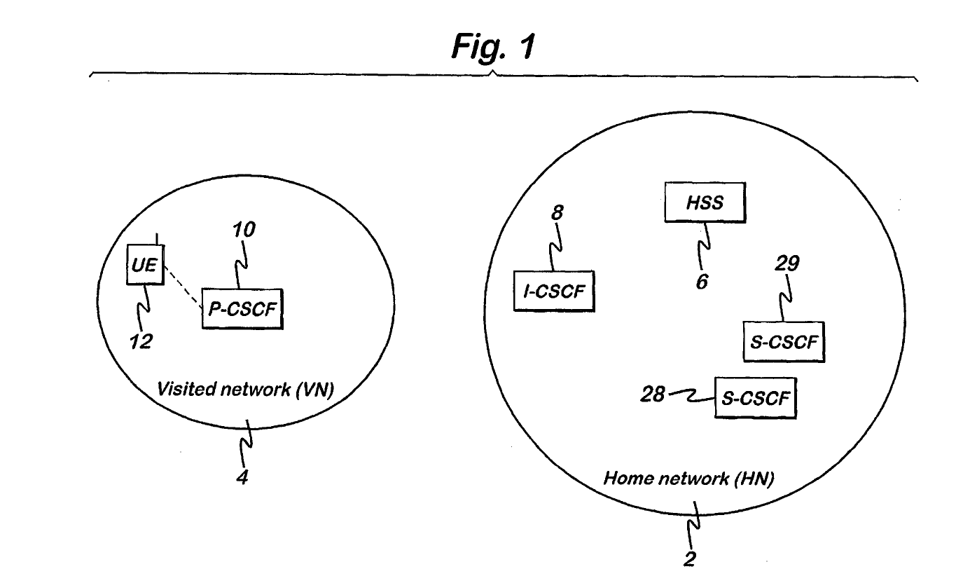

With reference to FIG. 1, there is described the network elements for initial registration of a subscriber located in a visited network.

Referring to FIG. 1 there is illustrated a home network (HN) 2 and a visited network (VN) 4. The home network 2 includes a home subscriber server (HSS) 6 and an interrogating call state control function (I-CSCF) 8. The home network also includes serving call state control functions (S-CSCFs), two of which are represented in FIG. 1 by reference numerals 28 and 29. The visited network 4 includes a proxy call state control function (P-CSCF) 10 and a user equipment (UE) 12 associated with a subscriber.

In the example of FIG. 1, the UE 12 is associated with the home network 2 and is normally connected in the home network 2. The UE is a roaming UE and has consequently roamed into the visited network 4. In accordance with known techniques, it is therefore necessary for the UE 12 to register with the home network 4.

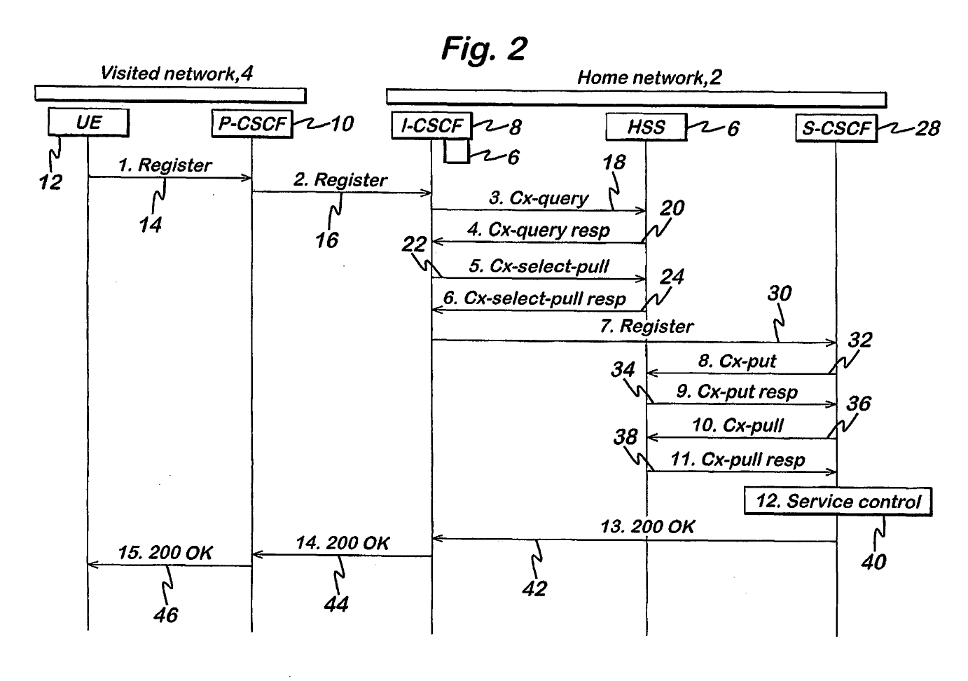

Referring to FIG. 2, there is illustrated the implementation of a technique for the initial registration of the UE 12 located in the visited network 4. It is assumed that radio bearers are already established for signalling, and a mechanism exists for the first message of the registration procedure to be forwarded from the UE 12 to the P-CSCF 10 in accordance with known techniques.

After the UE 12 has obtained its signalling channel through the access network (i.e. the visited network), registration can be performed. To initiate registration, the UE 12 sends a register signal, as identified by arrow 14, to the P-CSCF 10 in the visited network. The register information flow sent by the UE 12 includes its subscriber identity and the domain name of its home network 2.

Upon receipt of the register information flow, the P-CSCF 10 examines the home domain name to identify the entry point into the home network 2. The entry point into the home network 2 is through the I-CSCF 8. The P-CSCF 10 then sends the register information flow to the I-CSCF 8 of the home network as indicated by the arrow 16.

The register information flow sent from the P-CSCF 10 includes the P-CSCF “name” in a contact header, the subscriber identity (i.e. the mobile terminal's identity), and the subscriber contact name. A name-address resolution mechanism is utilised by the P-CSCF 10 in order to determine the address of the home network from the home domain name provided by the mobile terminal 12.

When the I-CSCF 8 receives the registration information flow from the P-CSCF 10, it examines the subscriber identity and the home domain name, and employs the services of a name-address resolution mechanism to determine the HSS address to contact.

The I-CSCF sends a query information flow, as represented by arrow 18, to the HSS. The query information flow includes the P-CSCF name, the user terminals subscriber identity, and the home domain name. The P-CSCF name is the contact name that the operator of the home network uses for future contact to that P-CSCF.

The HSS 6 checks whether the user is already registered with the home network. In accordance with known techniques, the HSS 6 then determines whether the user is allowed to register in that visited network.

The HSS sends a query response as indicated by arrow 20, to the I-CSCF 8. At this stage it is assumed that the authentication of the mobile terminal has been completed. The I-CSCF sends a select-pull signal, as represented by arrow 22, to the HSS 6. The select-pull signal includes the subscriber identity, and requests information from the HSS 6 relating to the required serving call state control function capabilities for the mobile terminal. The required serving call state control function capabilities are used to select an appropriate call state control function at a later step in the registration cycle.

Responsive to the select-pull signal from the I-CSCF 8, the HSS 6 sends a select-pull response signal, as represented by arrow 24, to the I-CSCF 8. The select-pull response signal details the required serving call state control function capabilities. The HSS provides information as to the required serving call state control functions in accordance with the mobile terminal's subscription information, held by the HSS 6 in the subscriber's home network.

The I-CSCF 8, including the S-CSCF allocation function as represented by block 26 in FIG. 2, determines the name of an appropriate S-CSCF in the home network 2. The I-CSCF 8 determines, in this example, the selection of S-CSCF 28. The I-CSCF, using the name of the S-CSCF, determines the address of the S-CSCF 28 through a name-address resolution mechanism, and then sends the register information flow to the selected S-CSCF 28 as represented by arrow 30. The register information flow includes the P-CSCF “name” in the contact header, and the user terminal subscriber identity and contact name.

The S-CSCF 28 sends a put signal, as represented by arrow 32, to the HSS 6. The put signal includes the subscriber identity of S-CSCF 28. This effectively registers the S-CSCF 28 as the serving call state control function for the UE 12 in the home network, so that the HSS can direct the call connections appropriately. The HSS stores the S-CSCF 28 name for the subscriber.

The HSS 6 sends a put response signal as represented by arrow 34, to the S-CSCF 28 to acknowledge receipt of the put signal.

On receipt of the put response information flow from the HSS 6, the S-CSCF 28 sends a pull information arrow 36, including the subscriber identity, to the HSS in order to download the subscriber profile to the HSS 6 to the S-CSCF 28. The S-CSCF 28 stores the P-CSCF name as supplied by the visited network. This represents the name to which the home network forwards the subsequent terminating session signalling for the UE 12.

The HSS 6 returns an information flow pull response signal, as represented by arrow 38, to the S-CSCF 28. The pull response signal includes the subscriber profile. The S-CSCF 28 then stores the subscriber profile for that indicated user. The S-CSCF may perform whatever service control procedures are appropriate, as indicated by block 40. The S-CSCF 28 then returns a 200 OK information flow as represented by arrow 42, to the I-CSCF 8. The 200 OK information flow is well known in the art, and includes the serving network contact name (in this case the home network 2) and the S-CSCF 28 name.

As represented by arrow 44, the I-CSCF then sends the information flow 200 OK to the P-CSCF 10. The I-CSCF releases all registration information after sending the information flow 200 OK. The P-CSCF 10 stores the serving network contact name, and sends the information flow 200 OK to the mobile terminal as represented by arrow 46. The registration process is then complete. The completion of the registration process, including the format of the 200 OK signals transmitted to complete such, is well known in the art.

In accordance with the present invention, as part of its registration process, the selected serving call state control function 30 provides the S-CSCF allocation function 26 with details as to its current load status. That is, on completing the registration process with the HSS 6, the serving call state control function 28 forwards to the interrogating call state control function 8 details as to its current load on signal 200 OK 42.

This information is then used by the interrogating call state control function 8 when determining the allocation of a serving call state control function for the registration of future subscribers.

The techniques by which a serving call state control function may determine its current load are well known. The load status of a serving call state control function can be formed from a variety of parameters. For example, the load may be determined based on the number of active calls currently handled by the S-CSCF or the number of subscribers currently registered with the S-CSCF. Each S-CSCF may provide the I-CSCF with a load figure based on predetermined levels of capacity for the S-CSCF. In providing the I-CSCF with information concerning its load, the S-CSCF may simply provide the I-CSCF with a figure indicating the current percentage of its maximum capacity which is currently being utilised.

In this way, the I-CSCF can use the current load of each S-CSCF function to spread the load, such that S-CSCFs with low loading are utilised. The I-CSCF is preferably provided with an algorithm for determining the selection of the S-CSCF based on the current load of the various S-CSCFs. The algorithm may be very simple. For example, if each S-CSCF provides the I-CSCF with a figure indicating the percentage of its resources currently being utilised, then the I-CSCF may simply select the S-CSCF with the lowest percentage.

However, more practically the allocation of the S-CSCF will additionally be determined based on further parameters. These further parameters may include a comparison of the services supported by the S-CSCF, and the services the subscriber requires. Other possible criteria for selecting the S-CSCF will be apparent to one familiar with the art. The implementation of an appropriate algorithm will be well within the scope of a skilled person, given the desired selection criteria.

The load information is preferably transmitted from the serving call state control function to the interrogating call state control function by making an extension to the session initiation protocol (SIP) used for performing the registration in known techniques. In this way the status information is included in the signals transmitted with arrow 42 of FIG. 2. Responsive to such signals the resource functionality provided in the interrogating call state control function updates status information and removes the status from the 200 OK message before further sending it on to the proxy call state control function.

The invention has been described herein with reference to a particularly preferred embodiment in which the S-CSCF allocation functionality 26 is provided by the interrogating call state control function. However the invention is not limited to this functionality being provided by the I-CSCF. This resource broker functionality, which allocates call state control function resource, can in fact be co-located with any network element. For example, the functionality may be co-located with the home subscriber server 6 of the home network 2. In such a scenario, during the profile downloading from the HSS 6, as illustrated by the arrows 32 to 38 in FIG. 2, the S-CSCF would inform the HSS of its status including its load situation.

It should also be noted that the S-CSCF allocation functionality may be provided in a separate physical entity rather than as part of the functionality of another network element.

The element which provides the S-CSCF allocation functionality may be considered to be a resource broker.

The serving call state control function does not have to update its status in every profile downloading. It may be required only to update its status in some periodic time frame. In overload situations the serving call status control function may be required to update its status more frequently.

In the above-described embodiments, the load information is provided to the I-CSCF by the S-CSCF providing information as to its current load status.

Alternatively, the S-CSCF may give an indication to the I-CSCF as to whether it can continue to receive new registrations. For example, if the S-CSCF is operating well within its capacity, it may send a signal to the I-CSCF that indicates that new registrations may continue to be sent, and the I-CSCF will proceed on this basis.

However, if the S-CSCF determines that it is operating at or near its load capacity, it may send a signal to the I-CSCF asking for further registrations not to be sent. This may take the form of new registrations not being sent for a default time period, e.g. twenty minutes. However, during that twenty minutes the load of the S-CSCF may reduce earlier than the twenty minute period, and available capacity in the S-CSCF is not efficiently utilised.

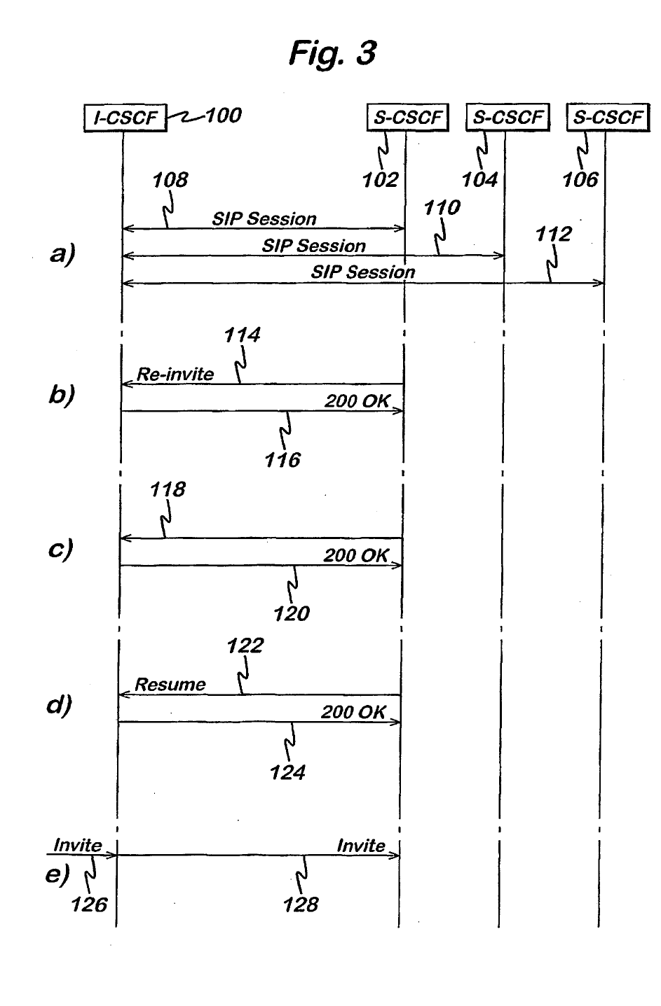

With reference to FIG. 3, a preferred technique for signalling between a S-CSCF and an I-CSCF is described. Referring to FIG. 3, it is assumed that an I-CSCF 100 is supporting three S-CSCFs, identified by reference numerals 102, 104 and 106. For the purposes of the examples of FIG. 3, it is assumed that a session has already been established for a set of subscribers using the I-CSCF 100, and the three S-CSCFs 102, 104 and 106 are supporting calls. As such, an SIP session is established between each of the S-CSCFs 102, 104, 106 and the I-CSCF 100, as represented by signal connections 108, 110 and 112 as shown in FIG. 3(a).

In the preferred messaging, once an SIP session is established with an S-CSCF, the S-CSCF provides its supporting I-CSCF with an indication as to whether or not it is able to initiate new registrations. This is done by issuing a control signal to the I-CSCF.

Referring to FIG. 3, it is assumed that the S-CSCF is operating with spare load capacity, and is therefore in a position to accept new registrations. As such, the S-CSCF 102 transmits a RE-INVITE message 114 to the I-CSCF 100, re-inviting the I-CSCF to establish new registrations therewith. This can be considered to be a ‘keep-alive’ mechanism.

The RE-INVITE message 114 is transmitted periodically in accordance with SIP specifications.

On receipt of the RE-INVITE signal the I-CSCF 100 sends an acknowledgement signal 200 OK as represented b signal 116. The I-CSCF 100 then further includes the S-CSCF 102 in selecting the S-CSCF for a new registration.

Referring to FIG. 3(c), it is assumed that the S-CSCF is operating with no spare load capacity, and is therefore unable to accept new registrations. As such the S-CSCF 102 transmits a SUSPEND message 118 to the I-CSCF, indicating that no further new registrations can be established with the S-CSCF 102.

On receipt of the SUSPEND signal the I-CSCF 100 sends an acknowledgement signal 200 OK as represented by signal 120. The I-CSCF 100 then does not include the S-CSCF 102 in selecting the S-CSCF for any new registration.

As illustrated by FIG. 3(d), at some time thereafter the load on the S-CSCF 102 is reduced sufficiently to enable the S-CSCF to receive new registrations. As such, the S-CSCF 122 transmits a RESUME message 122 to the I-CSCF.

On receipt of the RESUME message the I-CSCF 100 sends an acknowledgement signal 200 OK as represented by signal 124. The I-CSCF 100 then further includes the S-CSCF 102 in selecting the S-CSCF for a new registration. The RESUME message is only ever sent after a HOLD message.

Thus according to the present invention an existing profile downloading protocol is used to provide a S-CSCF allocation functionality in the network with an update on the status of call state control functions in the network.

Although the present invention has been described with reference to particular example communication exchanges and example network scenarios, it is not limited to any such examples. The scope of the present invention id determined by the appended claims, and one skilled in the art will appreciate the general applicability of the invention.

1-31. (canceled)

32. A method of allocating one of a plurality of serving call state control functions to a subscriber, the method including:
receiving load information from a plurality of serving call state control functions in a signalling message; and
determining a serving call state control function for the subscriber in dependence on the received load information, wherein the step of determining a serving call state control function is carried out by a network resource.

33. The method of claim 32 wherein the network resource is the interrogating call state control function.

34. The method of claim 33, wherein the network resource is a home subscriber server.

35. The method of claim 32, wherein the subscriber is either located in a visited network or a home network and is registered in a home network.

36. The method of claim 32, wherein the load information indicates the actual current load of the serving call state control function.

37. The method of claim 32, wherein the load information indicates the availability of the call state control function.

38. The method of claim 32, wherein the load information indicates a time period in which the serving call state control function cannot receive further subscriber registrations.

39. The method of claim 32, further including a session between a serving call state control function and interrogating call state control function for transmitting the availability information.

40. The method of claim 39, further including sessions between interrogating call state control function and a plurality of serving call state control functions.

41. The method claim 39, further including transmitting an unavailability signal within the session from the serving call state control function to interrogating call state control function to indicate unavailability of the serving call state control to receive subscriber registrations.

42. the method of claim 39, further including transmitting an availability signal within the session from the serving call state control function to the interrogating call state control function to indicate availability of the serving call state control function to receive subscriber registrations.

43. The method of claim 39 further including transmitting a keep-alive signal within the session from the serving call state control function to the interrogating call state control function to indicate availability of the serving call state control function to receive subscriber registrations.

44. The method according to claim 32, wherein the signalling message is related to subscriber registration.

45. The method according to claim 39, wherein the signalling message is related to a session between a serving call state control function and interrogating call state control function.

46. The method according to claim 44, wherein the signalling message is one of a 200 OK, INVITE, SUSPEND, or RESUME SIP Requests.

47. The method according to claim 44 wherein the signalling message is one of a Cx_Put, Cx_Put Resp, Cx_Pull, or a Cx_Pull Resp messages.

48. The method of claim 32 in which the serving call state control function is selected on a session basis.

49. A method according to claim 32 in which the subscriber is located in a home network or a visited network, and the serving call state control function is located in the home network.

50. A network element for allocating one of a plurality of serving call state control function means to a subscriber, the network including a home network comprising an interrogating call state control function means and a plurality of serving call state control function means;
wherein the interrogating call state control function means receives load information from a plurality of the serving call state control function means in a signalling message; and a broker associated with the network element determines a serving call state control function means for the subscriber in dependence on the received load information.

51. A network element according to claim 50, wherein the network element is the interrogating call state control function.

52. A network element according to claim 51, wherein the network element is a home subscriber server.

53. A network element according to claim 50, wherein the network further includes a visited network, wherein the subscriber is connected in either the visited network or the home network.

54. A network element according to claim 50 wherein the interrogating call state control function means receives load information from a plurality of serving call state control functions.

55. A network element according to claim 50 wherein the load information indicates the availability of a call state control function.

56. A network element according to claim 50 wherein the signalling message is related to subscriber registration.

57. A network element according to claim 50 further including a session between a serving call state control function for transmitting the availability information.

58. A network element according to claim 57 wherein the signalling message is related to a session between a serving call state control function and interrogating call state control function.

59. A network element according to claim 57, wherein the signalling message is one of a 200 OK, INVITE, SUSPEND, or RESUME SIP Requests.

60. A network element according to claim 56, wherein the signalling message is one of a Cx_Put, Cx_Put Resp, Cx_Pull, or a Cx_Pull Resp messages.

61. A mobile wireless communications system including a home network, wherein the home network includes a network element for allocating one of a plurality of serving call state control function means provided in the home network to a subscriber, the home network further comprising an interrogating call state control function means; wherein the interrogating call state control function means receives load information from a plurality of the serving call state control function means; and a broker associated with the network element determines a serving call state control function means for the subscriber in dependence on the received load information.

62. A mobile wireless communication system according to claim 61 further including a visited network, wherein the subscriber is connected in either the visited network or the home network.
